(19) United States
(12) Patent Application Publication
(10) Pub. No.: US 2026/0084565 A1
(43) Pub. Date: Mar. 26, 2026

(54) TECHNIQUES FOR CONTROLLING VEHICLE HIGH VOLTAGE POWER CONSUMPTION TO AVOID CHARGE TERMINATION DURING CHARGING AT HIGH STATE OF CHARGE AND COLD AMBIENT CONDITIONS

(71) Applicant: FCA US LLC, Auburn Hills, MI (US)

(72) Inventors: Rudolf Kharpuri, Auburn Hills, MI (US); Venkatasubramanian Sankara Raman, Auburn Hills, MI (US)

(21) Appl. No.: 18/894,259

(22) Filed: Sep. 24, 2024

(51) Int. Cl. B60L 53/62; B60L 53/66; B60L 58/27; H01M 10/44; H01M 10/615; H01M 10/625; H01M 10/63; H01M 10/6571; H02J 7/00

(52) U.S. Cl. CPC B60L 53/62; B60L 53/66; B60L 58/27; H01M 10/44; H01M 10/615; H01M 10/625; H01M 10/63; H01M 10/6571; H01M 2220/20; H02J 7/64

(57) ABSTRACT

A charging control method for an electrified vehicle includes detecting a high state of charge (SOC) and low ambient temperature charging condition and, in response thereto, controlling a thermal conditioning device of the electrified vehicle to thermally condition the high voltage battery system, wherein the thermal conditioning device is powered by a high voltage system of the electrified vehicle, controlling a charge current request for electrified vehicle supply equipment (EVSE) based on a load of the thermal conditioning device on the high voltage system, detecting a spike condition where an abrupt power-off of the thermal conditioning device causes the charge current request to the EVSE to exceed limits for the high voltage battery system and, in response thereto, temporarily decreasing the charge current request to the EVSE to prevent an overvoltage malfunction of the high voltage battery system.

### FIELD

The present application generally relates to electrified vehicles and, more particularly, to techniques for controlling high voltage power consumption to avoid vehicle charge termination during charging at high state of charge (SOC) and cold ambient conditions.

### BACKGROUND

An electrified vehicle includes a high voltage battery pack or system that provides electrical energy to one or more electric motors. During charging of the battery system, thermal components may be activated to provide thermal conditioning for optimized charging. Some of these high voltage components are connected to the same high voltage bus as the high voltage battery system. Cold ambient conditions, for example, limit current flow into (charging) and out of (discharging) the battery system. Once the desired thermal conditioning is achieved, the thermal components are powered off, which could cause a current spike at the high voltage bus. The resulting current spike at the high voltage bus could potentially degrade or damage the battery system. Accordingly, while such conventional electrified vehicle systems do work for their intended purpose, there exists an opportunity for improvement in the relevant art.

### SUMMARY

According to one example aspect of the invention, a charging control system for an electrified vehicle is presented. In one exemplary implementation, the charging control system comprises a thermal conditioning device powered by a high voltage system of the electrified vehicle and configured to thermally condition a high voltage battery system of the high voltage system and a controller configured to detect a charging condition where a state of charge (SOC) of the high voltage battery system exceeds an SOC threshold and an ambient temperature is less than an ambient temperature threshold and, in response to detecting the charging condition, control the thermal conditioning device to thermally condition the high voltage battery system, control a charge current request for electrified vehicle supply equipment (EVSE) based on a load of the thermal conditioning device on the high voltage system, detect a spike condition where an abrupt power-off of the thermal conditioning device causes the charge current request to the EVSE to exceed limits for the high voltage battery system, and in response to detecting the spike condition, temporarily decrease the charge current request to the EVSE to prevent an overvoltage malfunction of the high voltage battery system.

In some implementations, the controller is an electrified vehicle control unit (EVCU) that is configured to provide the charge current request to an on-board charger module (OBCM) of the electrified vehicle via a controller area network (CAN) bus, and wherein the OBCM is configured to control the charging current provided by the EVSE to the electrified vehicle. In some implementations, the thermal conditioning device is a high voltage heater device that is connected to the EVCU via a local interconnect (LIN) bus that provides slower communication compared to the CAN bus. In some implementations, the high voltage heater device is an electric coolant heater (ECH). In some implementations, the controller is configured to maintain a same charge current request when the abrupt power-off of the thermal conditioning device does not causes the charge current request to the EVSE to exceed limits for the high voltage battery system. In some implementations, the controller is configured to selectively adjust the charge current request when the power-off of the thermal conditioning device is not abrupt such that the controller is able to proactively account it.

According to another example aspect of the invention, a charging control method for an electrified vehicle is presented. In one exemplary implementation, the charging control method comprises detecting, by a controller of the electrified vehicle, a charging condition where an SOC of a high voltage battery system of the electrified vehicle exceeds an SOC threshold and an ambient temperature is less than an ambient temperature threshold, in response to detecting the charging condition, controlling a thermal conditioning device of the electrified vehicle to thermally condition the high voltage battery system, wherein the thermal conditioning device is powered by a high voltage system of the electrified vehicle, controlling, by the controller, a charge current request for EVSE based on a load of the thermal conditioning device on the high voltage system, detecting, by the controller, a spike condition where an abrupt power-off of the thermal conditioning device causes the charge current request to the EVSE to exceed limits for the high voltage battery system, and in response to detecting the spike conditioning, temporarily decreasing, by the controller, the charge current request to the EVSE to prevent an overvoltage malfunction of the high voltage battery system.

In some implementations, the controller is an EVCU that is configured to provide the charge current request to an OBCM of the electrified vehicle via a CAN bus, and wherein the OBCM is configured to control the charging current provided by the EVSE to the electrified vehicle. In some implementations, the thermal conditioning device is a high voltage heater device that is connected to the EVCU via a LIN bus that provides slower communication compared to the CAN bus. In some implementations, the high voltage heater device is an ECH. In some implementations, the method further comprises maintaining, by the controller, a same charge current request when the abrupt power-off of the thermal conditioning device does not causes the charge current request to the EVSE to exceed limits for the high voltage battery system. In some implementations, the method further comprises selectively adjusting, by the controller, the charge current request when the power-off of the thermal conditioning device is not abrupt such that the controller is able to proactively account it.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a plot depicting an example current spike and battery cell overvoltage malfunction caused by conventional charging control techniques according to the prior art;

FIG. 2 is a functional block diagram depicting an electrified vehicle having an example charging control system according to the principles of the present application; and

FIG. 3 is a flow diagram depicting an example charging control method for an electrified vehicle according to the principles of the present application.

### DESCRIPTION

As discussed above, during a charging process of an electrified vehicle, a supervisory controller (e.g., an electrified vehicle control unit, or EVCU) computes and sends the charging current request to an on-board charging module (OBCM) which in turn controls the current coming from the electrified vehicle supply equipment (EVSE). This current flows to a high voltage system or bus of the electrified vehicle and to the high voltage battery system. The charging current going into the high voltage battery system follows certain hard and soft limits based on various factors which could come from the OBCM, the EVSE, or the high voltage battery system itself (cell voltage limits, state of charge (SOC), state of health (SOH), temperature limits, etc.) and these parameters also vary at different ambient temperature conditions. The various high voltage components or loads on the high voltage bus, such as an auxiliary power module (APM) (e.g., a DC-DC converter) and thermal conditioning systems (an electric air compressor (EAC), an electric coolant heater (ECH), etc.) all consume power or current from the high voltage bus for their operation. The EVCU takes these high voltage loads into consideration during a charging session to compute the charging current request to the OBCM.

The thermal conditioning components (EAC, ECH, etc.) come into the picture while charging for conditioning the electrified vehicle and the high voltage battery system under all temperature conditions. Under one such temperature condition like cold ambient temperatures, the high voltage battery system will only allow for a small charging current due to limitations, e.g., due to cell chemistry or component protection. To optimize the charging of the high voltage battery system, it would be ideal to thermally condition it. Thus, the thermal conditioning loads can be operated to condition the high voltage battery system out of cold (or hot) conditions, and this would lead to opening up of the charging current limit, thereby increasing the charging current into the high voltage battery system and decreasing the charge time. The cold conditions while limiting the charging current into the battery, also limits the discharging current from the high voltage battery system. As such, the EVCU may pull additional current from the EVSE/OBCM to support the high voltage loads.

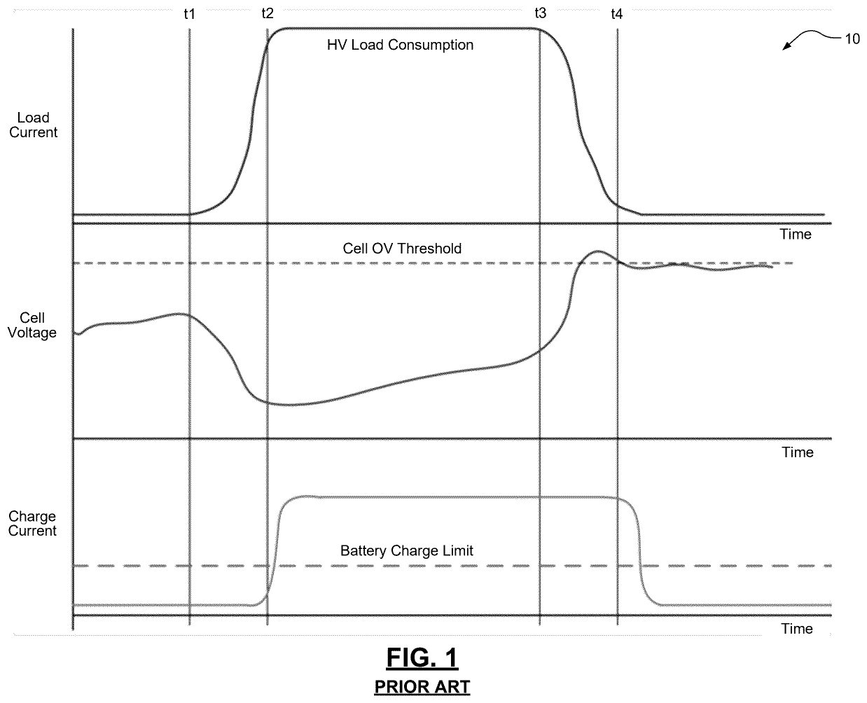

To account for the additional load on the high voltage bus, the EVCU increases the current request sent to the OBCM, which could be higher than the charging limit of the high battery system. This situation could occur at any SOC of the high voltage battery system. When the SOC is high or close to the charging complete condition (at this state, the battery is reaching its full capacity and cannot accept large amounts of current) and if the ambient temperature is cold (i.e., below a threshold), the thermal conditioning load (the ECH or another high voltage heating component) could come on to target and achieve the conditioning temperature set point and then shut off. This scenario is captured in the plot 10 of FIG. 1. Between times t1 and t2, the ECH turns on (e.g., ˜5-6 kilowatts of power drawn) and, initially, the high voltage battery system supports this load as depicted by the cell voltage of the battery dipping, but the EVCU will detect this surge in current and then raise the charge current request to the OBCM to compensate. As the OBCM pushes current into the electrified vehicle, the cell voltage gradually rises between times t2 and t3. Once the conditioning is achieved or as the temperature increases, the thermal load (the ECH) will shut off.

When the thermal load goes off the high voltage bus, power consumption from the EVSE suddenly drops, and since the system is reactive i.e., the current request takes time (few milliseconds) to be adjusted, a surge of current or voltage shows up on the high voltage system. This excess current on the high voltage bus must go somewhere if the OBCM didn't reduce its output and the only place that it can go into is the battery. This is evident from times t3 to t4 where the heater suddenly drops its power consumption load and the cell voltage rises to the point where it hits an over-voltage (OV) threshold. The EVCU will realize this and pull down the current request to stay within the charging limit of the battery, but this is too late. The EVCU is typically a slow controller (e.g., ˜100 millisecond response time), and the entire system is reactive in nature. So, by the time it reacts, some of the current that was consumed by the thermal load from the OBCM goes into the battery, causing a sudden spike in the cell voltage which could lead to a cell over voltage condition resulting in charging being terminated prematurely and a diagnostic code logged by the battery as a violation. The above reactions are not desirable, as they impact the charging time and charging to full aspects of the vehicle, which in turn impacts the customer. Additionally, the above outcomes are also not desirable for the high voltage battery system itself as it could lead to degradation of the component.

Accordingly, improved techniques for controlling high voltage power consumption to avoid vehicle charge termination during charging at high SOC and cold ambient conditions are presented herein. These techniques prevent over-charging the high voltage battery system by closely monitoring the conditioning temperature setpoint of the high voltage battery system as well as controlling the on-off operation of the high voltage loads (e.g., an ECH or other high voltage heater system). Additionally, these techniques also takes advantage of the slow actuation (or execution) time by the high voltage loads or devices, which are usually on a slower local interconnect network (LIN) bus compared to a faster controller area network (CAN) bus. By avoiding the above-described over-voltage malfunctions of the high voltage battery system, potential degradation or damage thereto can be avoided, thereby saving costs. These charging control techniques are also still able to provide adequate thermal conditioning of the high voltage battery system to mitigate or eliminate its current limitations and thereby improve or optimize charging times for an improved customer experience, particularly during high SOC and cold ambient temperature conditions.

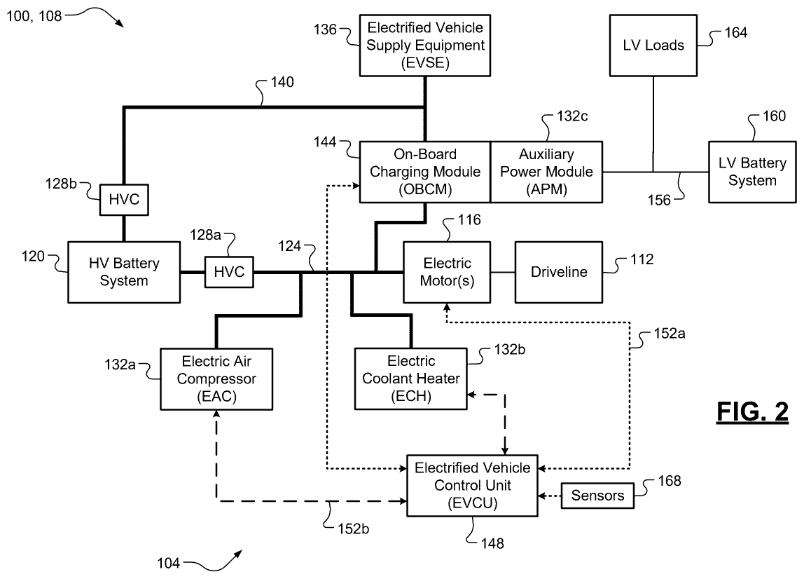

Referring now to FIG. 2, a functional block diagram depicting an example electrified vehicle 100 having an example charging control system 104 according to the principles of the present application is illustrated. The electrified vehicle 100 includes an electrified powertrain 108 configured to generate and transfer drive torque to a driveline 112 for vehicle propulsion. The electrified powertrain 108 generally comprises one or more electric motors 116 (e.g., which could each include a respective inverter) that are powered by a high voltage battery pack or system 120. For example only, the high voltage battery system 120 could comprise a plurality of lithium-ion type battery cells and could be rated at ˜400 volts. The high voltage battery system 120 is connected to a high voltage bus 124, with a high voltage contactor (HVC) 128a therebetween. High voltage loads 132 include thermal conditioning loads, such as an EAC 132a and an ECH 132b, and other high voltage components, such as an APM 132c. The high voltage battery system 120 is also configured to be charged/recharged via EVSE 136, which provides a temporary high voltage connection 140 to the high voltage battery system 120 with another HVC 128b therebetween.

This high voltage connection or bus 140 is controlled by an OBCM 144, which is connected to the APM 132c and is also in communication with an EVCU or other supervisory controller 148 via a controller area network (CAN) bus 152a. The EVCU 148 is also configured to communicate via the CAN 152a with the electric motor(s) 116 to provide a desired amount of drive torque to satisfy a driver torque request (e.g., from an accelerator pedal, not shown). The EVCU 148 is also configured to communicate with the thermal conditioning components—the EAC 132a and the ECH 132b—via a LIN bus 152b that is slower than the CAN bus 152a. The APM 132c is configured to step-down the voltage from the high voltage buses 124, 140 to support a low voltage bus 156 that is connected to a low voltage battery system 160 (e.g., a 12 volt battery system). Other low voltage vehicle accessory loads (displays, lights, etc.) 164 are configured to operate using power from the low voltage bus 156.

The EVCU 148 employs a closed-loop control mechanism (e.g., a proportional-integral, PI controller) during high voltage charging to request and control the amount of current coming from the EVSE 136 as well as to monitor the current flowing into the high voltage battery system 120 through the high voltage buses 124, 140 in the electrified vehicle 100. It is also responsible for controlling the OBCM 144 by modulating the current request based on certain factors as well as the other high voltage loads 132 connected to the system to support the charging process. For example, the current requested by the EVCU 148 could be based on hardware limits, namely the high voltage battery system's acceptable current, the high voltage battery system's SOC, the OBCM capability, the high voltage battery system's temperature, and the high voltage battery system/cell voltage(s), among other parameters. Further, for accounting the high voltage loads (or DC loads) in the system, the EVCU 148 will compensate this by requesting more charging current which will exceed the required current that the battery can accept to avoid discharging the battery. This compensation is dynamically adjusted based on the load demand. Various operating parameters, such as current/voltages of the high voltage system of the electrified vehicle 100 and temperatures (e.g., ambient temperature) can be obtained by the EVCU 148 using sensors 168. Some parameters, such as the SOC of the high voltage battery system 120, could be estimated (e.g., using a Kalman filter) based on other parameters (e.g., cell voltage/current).

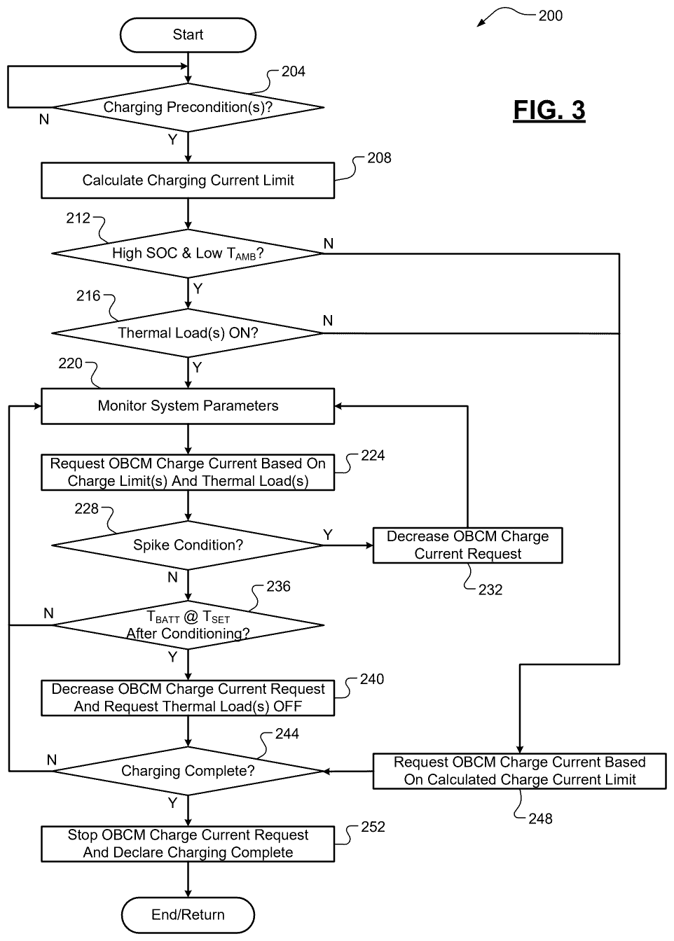

Referring now to FIG. 3, a flow diagram depicting an example charging control method 200 for an electrified vehicle according to the principles of the present application is illustrated. While the electrified vehicle 100 and its components are specifically referenced for descriptive/illustrative purposes, it will be appreciated that the method 200 could be applicable to any suitably configured electrified or hybrid vehicle. In method 200, the EVCU 148 detects whether the electrified vehicle is plugged in to the EVSE 136 via a respective charger cable (this could be AC or DC session) and is in a state to charge the high voltage battery system 120. When false, the method 200 ends. When true, the method 200 proceeds to 208. At 208, the EVCU 148 computes the charging current limit that the high voltage battery system 120 can accept as a function of its SOC and temperature. At 212, the EVCU 148 determines whether the charging current is limited due to high SOC and cold ambient temperature (e.g., as measured by sensors of the electrified vehicle 100 or estimated based on other parameters). When false, the method 200 proceeds to 248. When true, the method 200 proceeds to 216. At 216, the EVCU 148 determines whether the thermal load(s) (e.g., the ECH 132b) are activated to condition or warm up the high voltage battery system 120 to accept charge. When both the conditions are satisfied, then the method 200 proceeds to 220. Otherwise, the method 200 proceeds to 248.

At 220, the EVCU 148 monitors parameters of the thermal load like power consumed from the system and operational status including fault status, and it also continues to monitor the high voltage battery system's temperature and current flowing thereto or through. Based on the above, at 224, the EVCU 148 requests charge current from the OBCM 144 keeping in mind the charge constraints and loads in the system. During this time, a spike condition is monitored for at 228. This spike condition as previously described herein represents when the thermal load(s) shut off abruptly without notifying the EVCU 148 in advance. When true, the EVCU 148 further checks if the power that was consumed by the thermal load(s), i.e., the additional power that was requested from the OBCM 144, exceeds the charge current limit of the high voltage battery system 120. When false, the methos 200 proceeds to 236. When true, the method 200 proceeds to 232 where the EVCU 148 reacts instantly by dropping the current request to the OBCM 144 below the charging limit of the high voltage battery system 120 to avoid overcharging or violating the high voltage battery system's limits. This is possible because the controls related to the thermal devices 132 inside the EVCU 148 operate at a slower rate (e.g., ˜100 ms) than the controls related to charging the high voltage battery system (e.g., ˜25 ms), even if the closed loop control method (or PI control) employed is slower in nature (which eventually corrects itself but takes too much time).

This reaction will reduce the current output by the OBCM 144 as such, the system will stabilize itself. Then the method 200 returns to 220 and continues monitoring the parameters from the thermal load, battery, and other system conditions to allow and continue charging again. However, if there is no interruption of power by the thermal device(s), the method 200 proceeds to 236 where the EVCU 148 evaluates if the temperature of the battery system 120 (T_{BATT}) has reached the temperature set point (T_{SET}) is reached or is very close to the target, after which at 240, the EVCU 148 will request the OBCM 144 to lower its output current and then request the thermal load to stop operating. This operation in nature is not reactive and, as such, the method 200 controls the exact amount of current into the system. After this point, the high voltage battery system 120 should no longer be in a cold condition as such the normal charging process can continue till the battery has reached its capacity at 244. At 248, the EVCU 148 requests charge current from the OBCM 144 based on the calculated current charge limit (from 208) when both 212 and 216 were false. When charging is determined to be complete at 244, the charge current request to the OBCM 144 can be stopped and charging can be declared complete at 252 and the method 200 ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A charging control system for an electrified vehicle, the charging control system comprising:
a thermal conditioning device powered by a high voltage system of the electrified vehicle and configured to thermally condition a high voltage battery system of the high voltage system; and
a controller configured to detect a charging condition where a state of charge (SOC) of the high voltage battery system exceeds an SOC threshold and an ambient temperature is less than an ambient temperature threshold and, in response to detecting the charging condition:
control the thermal conditioning device to thermally condition the high voltage battery system;
control a charge current request for electrified vehicle supply equipment (EVSE) based on a load of the thermal conditioning device on the high voltage system;
detect a spike condition where an abrupt power-off of the thermal conditioning device causes the charge current request to the EVSE to exceed limits for the high voltage battery system; and
in response to detecting the spike condition, temporarily decrease the charge current request to the EVSE to prevent an overvoltage malfunction of the high voltage battery system.

2. The charging control system of claim 1, wherein the controller is an electrified vehicle control unit (EVCU) that is configured to provide the charge current request to an on-board charger module (OBCM) of the electrified vehicle via a controller area network (CAN) bus, and wherein the OBCM is configured to control the charging current provided by the EVSE to the electrified vehicle.

3. The charging control system of claim 2, wherein the thermal conditioning device is a high voltage heater device that is connected to the EVCU via a local interconnect (LIN) bus that provides slower communication compared to the CAN bus.

4. The charging control system of claim 3, wherein the high voltage heater device is an electric coolant heater (ECH).

5. The charging control system of claim 1, wherein the controller is configured to maintain a same charge current request when the abrupt power-off of the thermal conditioning device does not causes the charge current request to the EVSE to exceed limits for the high voltage battery system.

6. The charging control system of claim 1, wherein the controller is configured to selectively adjust the charge current request when the power-off of the thermal conditioning device is not abrupt such that the controller is able to proactively account it.

7. A charging control method for an electrified vehicle, the charging control method comprising:
detecting, by a controller of the electrified vehicle, a charging condition where a state of charge (SOC) of a high voltage battery system of the electrified vehicle exceeds an SOC threshold and an ambient temperature is less than an ambient temperature threshold; and
in response to detecting the charging condition:
controlling a thermal conditioning device of the electrified vehicle to thermally condition the high voltage battery system, wherein the thermal conditioning device is powered by a high voltage system of the electrified vehicle;
controlling, by the controller, a charge current request for electrified vehicle supply equipment (EVSE) based on a load of the thermal conditioning device on the high voltage system;
detecting, by the controller, a spike condition where an abrupt power-off of the thermal conditioning device causes the charge current request to the EVSE to exceed limits for the high voltage battery system; and
in response to detecting the spike conditioning, temporarily decreasing, by the controller, the charge current request to the EVSE to prevent an overvoltage malfunction of the high voltage battery system.

8. The charging control method of claim 7, wherein the controller is an electrified vehicle control unit (EVCU) that is configured to provide the charge current request to an on-board charger module (OBCM) of the electrified vehicle via a controller area network (CAN) bus, and wherein the OBCM is configured to control the charging current provided by the EVSE to the electrified vehicle.

9. The charging control method of claim 8, wherein the thermal conditioning device is a high voltage heater device that is connected to the EVCU via a local interconnect (LIN) bus that provides slower communication compared to the CAN bus.

10. The charging control method of claim 9, wherein the high voltage heater device is an electric coolant heater (ECH).

11. The charging control method of claim 7, further comprising maintaining, by the controller, a same charge current request when the abrupt power-off of the thermal conditioning device does not causes the charge current request to the EVSE to exceed limits for the high voltage battery system.

12. The charging control method of claim 7, further comprising selectively adjusting, by the controller, the charge current request when the power-off of the thermal conditioning device is not abrupt such that the controller is able to proactively account it.
